(19) United States
(12) Patent Application Publication
(10) Pub. No.: US 2025/0183433 A1
(43) Pub. Date: Jun. 5, 2025

(54) ENERGY STORAGE APPARATUS

(71) Applicant: GS Yuasa International Ltd., Kyoto-shi (JP)

(72) Inventor: Yosuke NISHIMURA, Kyoto-shi (JP)

(73) Assignee: GS Yuasa International Ltd., Kyoto-shi (JP)

(21) Appl. No.: 18/729,975

(22) PCT Filed: Jan. 19, 2023
(86) PCT No.: PCT/JP2023/001437

§ 371 Date: Feb. 11, 2025

(30) Foreign Application Priority Data
Jan. 26, 2022 (JP) 2022-010003

(51) Int. Cl. H01M 50/176; H01M 10/0525; H01M 50/291; H01M 50/296; H01M 50/553

(52) U.S. Cl. CPC H01M 50/176; H01M 10/0525; H01M 50/291; H01M 50/296; H01M 50/553

(57) ABSTRACT

An energy storage apparatus of the present embodiment includes an energy storage device, an adjacent member, and a terminal member arrayed sequentially in a first direction, and a first protruding part protruding from the terminal member toward the adjacent member. The adjacent member includes a first surface expanding in a direction orthogonal to the first direction and facing the terminal member, and a second surface expanding in a direction orthogonal to the first direction and faces the energy storage device. The first surface includes a first recess recessed toward the second surface at a position corresponding to the first protruding part.

### TECHNICAL FIELD

The present invention relates to an energy storage apparatus including a plurality of energy storage devices.

### BACKGROUND ART

Conventionally, an assembled battery including a plurality of battery cells has been known (see Patent Document 1). As shown in FIG. 10, in the assembled battery 500, each battery cell 501 includes a box-shaped case 502 capable of housing a flat wound electrode assembly, and the plurality of battery cells 501 are arrayed in a direction in which the wide surfaces of the case 502 face each other.

In the assembled battery 500, cooling plates 503 each having a predetermined shape are disposed between the battery cells 501 arrayed and on both outer sides in the battery cell array direction, in a state of being in close contact with the wide surface of the case. The cooling plate 503 functions as a heat dissipation member for efficiently dissipating heat generated in each battery cell 501 during use, and has a shape capable of introducing a cooling fluid (typically, air) between the battery cells 501. The cooling plate 503 is made of polypropylene or another synthetic resin.

In the assembled battery 500, a pair of end plates 504 and 505 is disposed further outside the cooling plates 503 disposed on both outer sides of the battery cells 501 and the cooling plates 503 arrayed as described above. Then, the entire battery cell group and the end plates 504 and 505 are restrained in a state where a load is applied in the layering direction (array direction) of the restrained body 507 by a plurality of fastening restraint bands 506 attached so as to bridge (connect) both the end plates 504 and 505. More specifically, the end portion of the restraint band 506 is tightened and fixed to the end plate 504 by a screw 508, whereby the restrained body 507 is restrained so that a prescribed restraint pressure is applied in the array direction thereof.

In recent years, from the demand for miniaturization of the assembled battery 500, it is conceivable to reduce the thickness by forming the end plates 504 and 505 with metal plates or the like (reducing the dimension in the battery cell array direction). In this case, the tip of the screw 508 for fixing the end portion of the restraint band 506 to the end plates 504 and 505 protrudes from the end plates 504 and 505 toward the cooling plate 503. It is conceivable to provide a hole in the battery cell array direction in the cooling plate 503 disposed between the battery cell 501 and the end plates 504 and 505 to prevent contact between the cooling plate 503 and the screw 508 (protruding part protruding from the end plates 504, 505).

However, in this case, it is necessary to insulate the battery cell 501 from the screw (protruding part) 508, and it is necessary to secure the strength since the restraint pressure in the battery cell array direction is applied to the cooling plate 503, and the thickness of the cooling plate 503 disposed between the battery cell 501 and the end plates 504 and 505 needs to be increased (large in size in the battery cell array direction).

### PRIOR ART DOCUMENTS

### Patent Documents

Patent Document 1: JP-A-2020-61383

### SUMMARY OF THE INVENTION

### Problems to be Solved by the Invention

An object of the present embodiment is to provide an energy storage apparatus capable of preventing an increase in thickness of an adjacent member while preventing contact between the adjacent member and a protruding part.

### Means for Solving the Problems

An energy storage apparatus according to the present embodiment includes:
an energy storage device, an adjacent member, and a terminal member arrayed sequentially in a first direction; and
a first protruding part protruding from the terminal member toward the adjacent member,
the adjacent member includes a first surface expanding in a direction orthogonal to the first direction and facing the terminal member, and a second surface expanding in a direction orthogonal to the first direction and faces the energy storage device, and
the first surface includes a first recess recessed toward the second surface at a position corresponding to the first protruding part.

### Advantages of the Invention

As described above, according to the present embodiment, it is possible to provide an energy storage apparatus capable of preventing the thickening of an adjacent member while preventing the contact between the adjacent member and the protruding part.

### BRIEF DESCRIPTION OF THE DRAWINGS

FIG. 1 is a perspective view of an energy storage apparatus according to the present embodiment.

FIG. 2 is an exploded perspective view in which a part of the configuration of the energy storage apparatus is omitted.

FIG. 3 is a front view of the energy storage apparatus.

FIG. 4 is a cross-sectional view of an end portion of the energy storage apparatus taken along line IV-IV in FIG. 3.

FIG. 5 is a view of a third adjacent member provided in the energy storage apparatus as viewed from a second surface side.

FIG. 6 is a view of the third adjacent member as viewed from a first surface side.

FIG. 7 is a cross-sectional view taken along line VII-VII in FIG. 6.

FIG. 8 is a cross-sectional view taken along line VIII-VIII in FIG. 6.

FIG. 9 is a view for describing a positional relationship between a first contact portion included in a first surface and a first recess included in a second surface of the third adjacent member.

FIG. 10 is a perspective view of a conventional assembled battery.

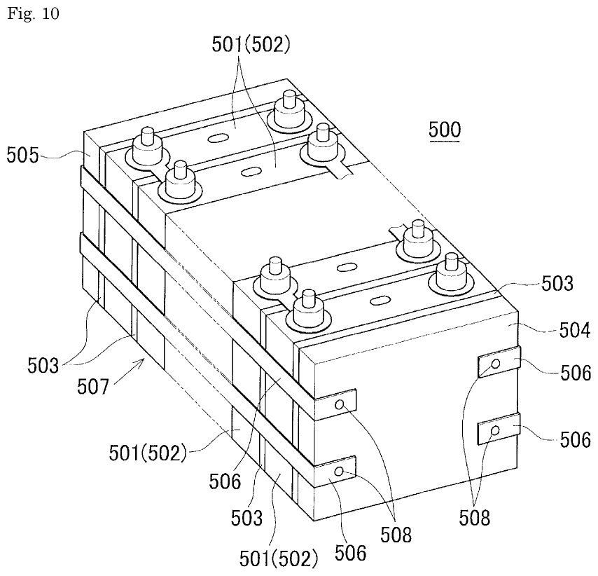

### MODE FOR CARRYING OUT THE INVENTION

(1) An energy storage apparatus according to the present embodiment includes:
an energy storage device, an adjacent member, and a terminal member arrayed sequentially in a first direction; and
a first protruding part protruding from the terminal member toward the adjacent member,
the adjacent member includes a first surface expanding in a direction orthogonal to the first direction and facing the terminal member, and a second surface expanding in a direction orthogonal to the first direction and faces the energy storage device, and
the first surface includes a first recess recessed toward the second surface at a position corresponding to the first protruding part.

As described above, by providing the first recess at the position corresponding to the first protruding part on the first surface of the adjacent member, contact between the first protruding part and the adjacent member can be prevented.

(2) In the energy storage apparatus according to (1) above, in the energy storage apparatus, the second surface may include a contact portion being brought into contact with the energy storage device, and a space forming portion provided at a position where a gap is formed between the space forming portion and the energy storage device in the first direction, and
the first recess may be arrayed at a position corresponding to the contact portion on the first surface.

By providing the first recess using a portion (portion corresponding to the contact portion) of the adjacent member protruding toward the energy storage device in order to form a space (gap) usable for heat insulation, cooling, or the like of the energy storage device, it is also possible to prevent an increase in size (increase in thickness) of the adjacent member in the first direction. That is, in the case where the first recess is provided in the portion corresponding to the space forming portion in the adjacent member (in other words, a portion having a smaller dimension in the first direction than a portion corresponding to the contact portion), if the dimension of the adjacent member in the first direction is secured to secure the strength of the portion corresponding to the first recess, the dimension of the adjacent member in the first direction increases. However, by providing the first recess in the portion corresponding to the contact portion in the adjacent member (in other words, a portion having a larger dimension in the first direction than a portion corresponding to the space forming portion), the strength of the portion corresponding to the first recess can be secured without increasing the dimension of the adjacent member in the first direction.

(3) In the energy storage apparatus according to (2) above, in the energy storage apparatus,
the second surface may include a plurality of projecting ridges projecting toward the energy storage device and extending in a second direction orthogonal to the first direction, and
the plurality of projecting ridges may be disposed on the second surface at intervals in a third direction orthogonal to each of the first direction and the second direction, and at least one tip of the plurality of projecting ridges in a projecting direction may be brought into contact with the energy storage device, and
a tip of at least one of the plurality of projecting ridges may be configured of the contact portion, and
the first recess may be provided at a position corresponding to the at least one projecting ridge on the first surface.

According to such a configuration, a plurality of flow path spaces which extend in the second direction along the projecting ridges and through which the fluid for regulating the temperature of the energy storage device can flow are formed between the energy storage device and the adjacent member, and the first recess is formed at the portion where the projecting ridges (the projecting ridges including the contact portions) are formed in the adjacent member, whereby the dimension of the adjacent member in the first direction can be suppressed.

(4) In the energy storage apparatus according to (3) above, in the energy storage apparatus,
in the at least one projecting ridge, a dimension of a first portion in the third direction corresponding to the first recess in the second direction may be larger than a dimension of a second portion in the third direction being a portion other than the first portion.

According to such a configuration, in the flow path space formed by the projecting ridge including the first portion, the width (dimension in the third direction) of the portion corresponding to the first portion in the second direction is smaller than the width of the other portion (portion corresponding to the second portion), so that the width of the flow path space is locally narrowed in the second direction. Therefore, a turbulent flow is generated in the flow of the fluid for regulating the temperature when the fluid for regulating the temperature flows in the flow path space, and as a result, the heat exchange efficiency between the energy storage device and the fluid for regulating the temperature is improved.

(5) In the energy storage apparatus according to any one of (1) to (4) above,
the energy storage apparatus may include a second protruding part protruding from the terminal member toward the adjacent member around the first protruding part,
a protruding amount of the second protruding part may be smaller than a protruding amount of the first protruding part, and
the first surface may include a second recess provided at a position corresponding to the second protruding part around the first recess, and a depth of the second recess in the first direction may be shallower than a depth of the first recess in the first direction.

In this manner, by providing the recesses (the first recess and the second recess) having a range and a depth corresponding to the protruding parts (the first protruding part and the second protruding part) protruding from the terminal member on the first surface of the adjacent member, it is possible to more reliably suppress interference with the protruding parts of the adjacent member.

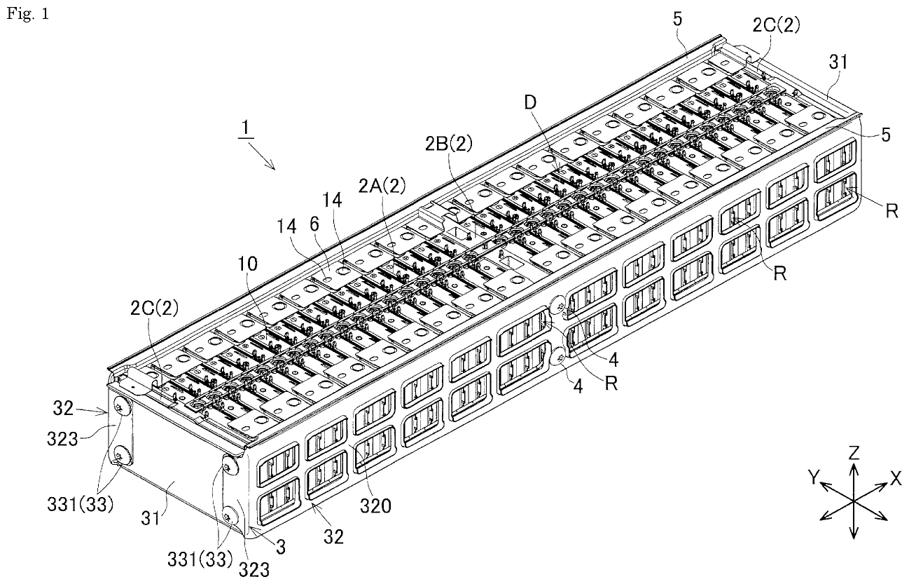

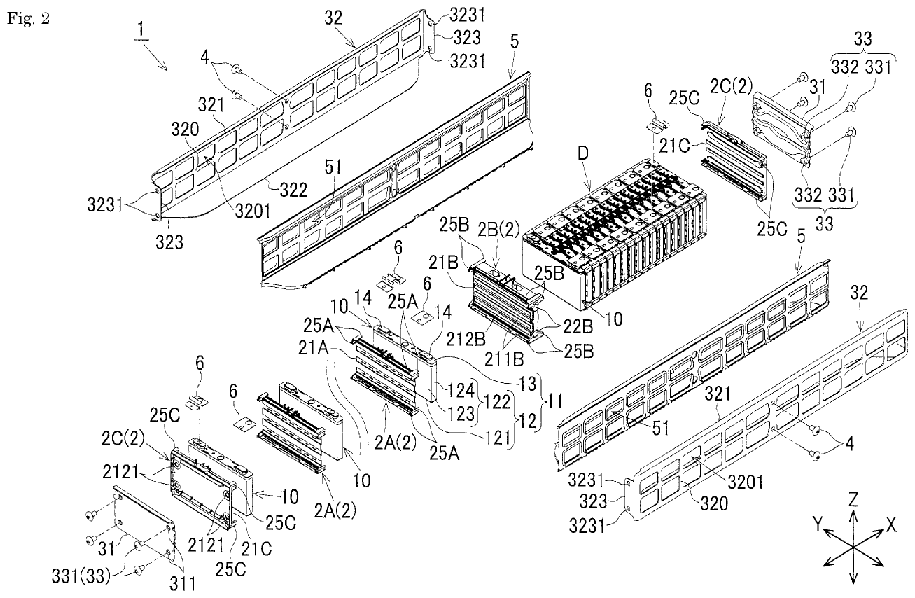

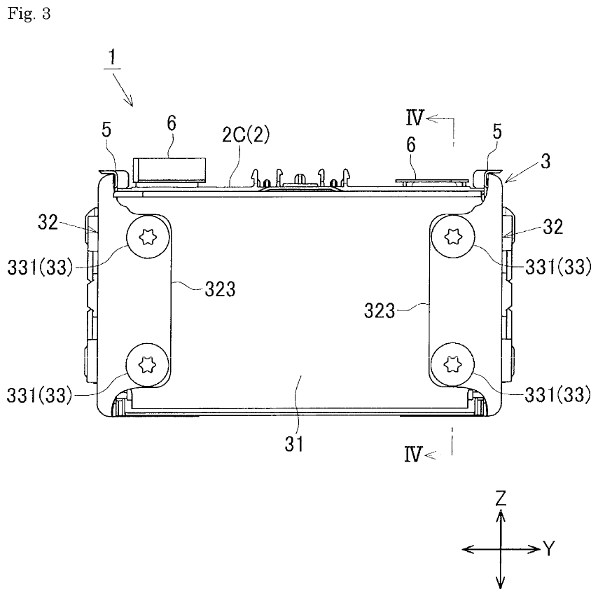

Hereinafter, an embodiment of the present invention will be described with reference to FIGS. 1 to 9. Note that the names of the constituent members (constituent elements) of the present embodiment are those in the present embodiment, and may be different from the names of the constituent members (constituent elements) in the background art.

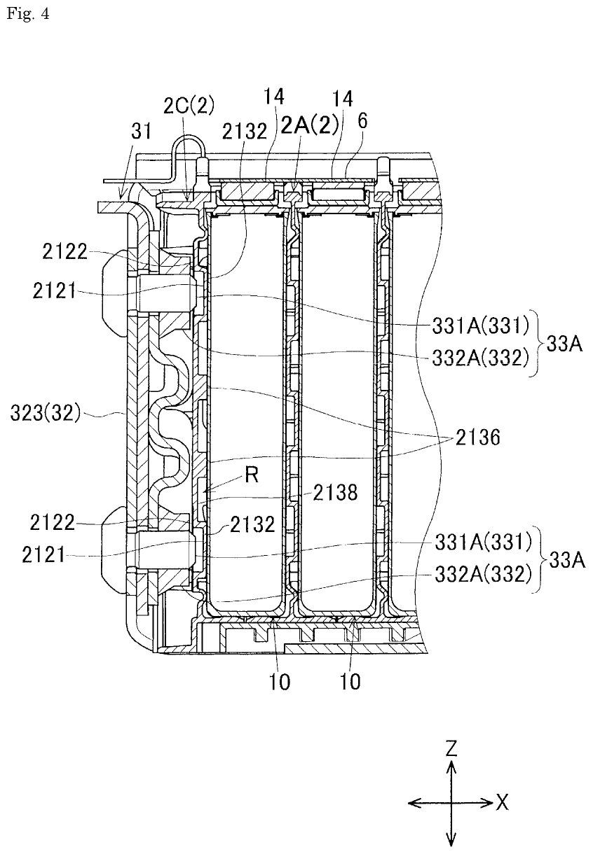

As shown in FIGS. 1 to 4, an energy storage apparatus 1 of the present embodiment includes: a plurality of energy storage devices 10 arrayed in a predetermined direction; a plurality of adjacent members 2 which are disposed adjacently to the energy storage devices 10 in the predetermined direction; and a holding member 3 which holds the plurality of energy storage devices 10 and the plurality of adjacent members 2. At an end portion of the energy storage apparatus 1 in a predetermined direction, the energy storage devices 10, the adjacent members 2, and members forming the holding member 3 (terminal members 31 in the example of the present embodiment) are arrayed in this order in the predetermined direction (see FIG. 4). The energy storage apparatus 1 includes at least one protruding part 33A which protrudes toward the adjacent member 2 from the terminal member 31. The energy storage apparatus 1 of the present embodiment includes the plurality of protruding parts 33A, and each of the plurality of protruding parts 33A includes a first protruding part 331A and a second protruding part 332A disposed around the first protruding part 331A. In the energy storage apparatus 1 of the present embodiment, the first protruding part 331A and the second protruding part 332A are formed of members 331 and 332 which connect members 31 and 32 forming the holding member 3 to each other.

The energy storage apparatus 1 includes: a first fastening member 4 which fixes at least one adjacent member 2 to the holding member 3; at least one insulator 5 which is disposed between the plurality of energy storage devices 10 and the holding member 3; and a plurality of bus bars 6 which connect the different energy storage devices 10 to each other in a conductive manner.

Each of the plurality of energy storage devices 10 is a primary battery, a secondary battery, a capacitor, or the like. The energy storage device 10 of the present embodiment is a nonaqueous electrolyte secondary battery which can be charged and discharged. More specifically, the energy storage device 10 is a lithium ion secondary battery utilizing electron transfer caused by transfer of lithium ions.

To be more specific, each energy storage device 10 includes: an electrode assembly; a case 11 which houses the electrode assembly together with an electrolyte solution; an external terminal 14 at least a part of which is exposed to the outside of the case 11; and a current collector which connects the electrode assembly and the external terminal 14 to each other.

In the electrode assembly, a positive electrode and a negative electrode are alternately layered with a separator interposed therebetween. In this electrode assembly, lithium ions move between the positive electrode and the negative electrode, whereby the energy storage device 10 is charged and discharged.

The case 11 includes a case body 12 having an opening, and a plate-like lid plate 13 that covers (closes) the opening of the case body 12. The case body 12 has a rectangular tube shape (that is, a bottomed rectangular tube shape) in which one end portion in the opening direction is covered, and the case 11 has a rectangular parallelepiped shape (hexagonal shape).

Specifically, the case body 12 includes a plate-shaped closing part 121 and a cylindrical body part (peripheral wall) 122 connected to a peripheral edge of the closing part 121.

The closing part 121 is a portion positioned at a lower end of the case body 12 when the case body 12 is disposed in a posture in which the opening faces upward (that is, serving as a bottom wall of the case body 12 when the opening faces upward). The closing part 121 has a rectangular shape when viewed from the normal direction of the closing part 121.

The body part 122 has a rectangular tube shape, more specifically, a flat rectangular tube shape. The body part 122 includes a pair of long walls 123 extending from long sides of the peripheral edge of the closing part 121, and a pair of short walls 124 extending from short sides of the peripheral edge of the closing part 121. In the body part 122, the short wall 124 connects the corresponding end portions of the pair of long walls 123 to each other to form the body part 122 having a rectangular tube shape.

The lid plate 13 is a rectangular plate-like member that covers the opening of the case body 12. The lid plate 13 is joined to the case body 12 in a state where a peripheral edge of the lid plate 13 is overlapped with an opening peripheral edge of the case body 12, thereby forming the case 11.

The case 11 described above has a flat rectangular parallelepiped shape, and the plurality of energy storage devices 10 are arrayed in the predetermined direction in a state where wide surfaces (long walls 123) of the case 11 face each other.

The external terminal 14 is a portion which is electrically connected to the external terminal 14 of another energy storage device 10, an external device, or the like. The external terminal 14 is formed of a conductive member. The external terminal 14 may be formed of a metal material having high weldability, such as an aluminum-based metal material such as aluminum or an aluminum alloy, or a copper-based metal material such as copper or a copper alloy.

In the following description, a direction (first direction) in which the plurality of energy storage devices 10 are arrayed is defined as an X-axis direction of an orthogonal coordinate system, a direction (second direction) in which the short walls 124 of the case 11 face each other is defined as a Y-axis direction of the orthogonal coordinate system, and a direction (third direction) in which the lid plate 13 and the closing part 121 face each other is defined as a Z-axis direction of the orthogonal coordinate system.

The adjacent member 2 has an insulating property, and is disposed between the energy storage devices 10 arrayed parallel to each other in the X-axis direction or between the energy storage device 10 and a member (in the example of the present embodiment, a part of the holding member 3) arrayed parallel to the energy storage device 10 in the X-axis direction. The adjacent member 2 of the present embodiment is formed of resin. The adjacent member 2 forms a flow path (flow path space) R through which a fluid for regulating the temperature (a gas such as air in the example of the present embodiment) can flow between the adjacent member 2 and the adjacent energy storage device 10. The energy storage apparatus 1 of the present embodiment includes the plurality of adjacent members 2, and the plurality of adjacent members 2 include a plurality of kinds of adjacent members 2A, 2B, and 2C.

To be more specific, the plurality of adjacent members 2 include: a first adjacent member 2A which is disposed between two energy storage devices 10 disposed adjacently to each other; a second adjacent member 2B which is disposed between the energy storage devices 10 disposed adjacently to each other and is fixed to the holding member 3; and a third adjacent member 2C which is disposed between the member 31 forming the holding member 3 and the energy storage device 10 disposed at the outermost end in the X-axis direction and is disposed adjacently to the energy storage device 10. That is, the energy storage apparatus 1 includes the first adjacent member 2A, the second adjacent member 2B, and the third adjacent member 2C as the adjacent members 2. The energy storage apparatus 1 of the present embodiment includes a plurality of first adjacent members 2A, one second adjacent member 2B, and two (a pair of) third adjacent members 2C. Each of the plurality of first adjacent members 2A is disposed between the energy storage devices 10 except for a portion between the energy storage devices 10 where the second adjacent member 2B is disposed.

Each of the plurality of first adjacent members 2A includes: a first body part 21A which expands in a direction orthogonal to the X-axis direction between the energy storage devices 10 disposed adjacently to each other in the X-axis direction; and at least one first restricting part 25A which restricts movement of the energy storage devices 10 disposed adjacently to the first body part 21A with respect to the first body part 21A. Each of the plurality of first adjacent members 2A forms at least one flow path R through which the fluid for regulating the temperature can flow between the first adjacent member 2A and the adjacent energy storage device 10 to each of the plurality of first adjacent members 2A.

The first body part 21A is a portion which faces the long wall 123 of the case 11 of the energy storage device 10 in a state where a part of the first body part 21A is brought into contact with the long wall 123. The first body part 21A forms a flow path R through which the fluid for regulating the temperature can flow between the first body part 21A and the energy storage device 10 disposed adjacently to the first body part 21A in cooperation with the energy storage device 10. In the present embodiment, the first body part 21A has a rectangular shape having a size corresponding to the size of the energy storage device 10 as viewed in the X-axis direction, and a cross-sectional shape of the first body part 21A along an X-Z plane (a plane including the X-axis direction and the Z-axis direction) is a rectangular waveform.

The first restricting parts 25A extend in the X-axis direction from at least corner portions of the rectangular first body part 21A, and are brought into contact with the energy storage device 10 (to be more specific, the case 11) disposed adjacently to the first body part 21A from the outside in the Y-Z plane (a plane including the Y-axis direction and the Z-axis direction) direction thus restricting the relative movement of the energy storage device 10 in the Y-Z plane direction with respect to the first body part 21A. In the present embodiment, the first restricting parts 25A extend from the first body part 21A toward one side and the other side in the X-axis direction, respectively.

The second adjacent member 2B includes: a second body part 21B which expands in a direction (Y-Z plane direction) orthogonal to the X-axis direction between two adjacent energy storage devices 10; and a second fastening member 22B which is used for fixing the second adjacent member 2B to the holding member 3. The second adjacent member 2B has at least one second restricting part 25B which restricts the movement of the energy storage device 10 disposed adjacently to the second body part 21B with respect to the second body part 21B. The second adjacent member 2B also forms at least one flow path R through which the fluid for regulating the temperature can flow between the second adjacent member 2B and the adjacent energy storage device 10.

The second body part 21B is a portion which faces the long wall 123 of the case 11 of the energy storage device 10 in a state where a part of the second body part 21B is brought into contact with the long wall 123. The second body part 21B forms a flow path R through which the fluid for regulating the temperature can flow between the second body part 21B and the energy storage device 10 disposed adjacently to the second body part 21B in cooperation with the energy storage device 10. The dimension of the second body part 21B in the X-axis direction is larger than the dimension of the first body part 21A in the X-axis direction (that is, thick). The second body part 21B of the present embodiment has a rectangular shape having a size corresponding to the size of the energy storage device 10 as viewed in the X-axis direction. The second body part 21B has a plurality of projecting ridges 211B each extending in the Y-axis direction and arrayed at intervals in the Z-axis direction. The plurality of projecting ridges 211B project from an opposing surface 212B of the second body part 21B which faces the energy storage device 10.

The second fastening member 22B is disposed at each end of the second body part 21B in the Y-axis direction. Each of the plurality of second fastening members 22B engages with the first fastening member 4 to fasten the second adjacent member 2B and the holding member 3. Each of the second fastening members 22B of the present embodiment is an insert nut. Each of the first fastening members 4 of the present embodiment is a bolt, and fastens the second adjacent member 2B and the holding member 3 by engaging (screwing) with the second fastening member 22B in a state where the holding member 3 is inserted.

The second restricting parts 25B extend in the X-axis direction from at least corner portions of the rectangular second body part 21B, and are brought into contact with the energy storage device 10 (to be more specific, the case 11) disposed adjacently to the second body part 21B from the outside in the Y-Z plane direction thus restricting the relative movement of the energy storage device 10 in the Y-Z plane direction with respect to the second body part 21B. In the present embodiment, the second restricting parts 25B extend from the second body part 21B toward one side and the other side in the X-axis direction, respectively.

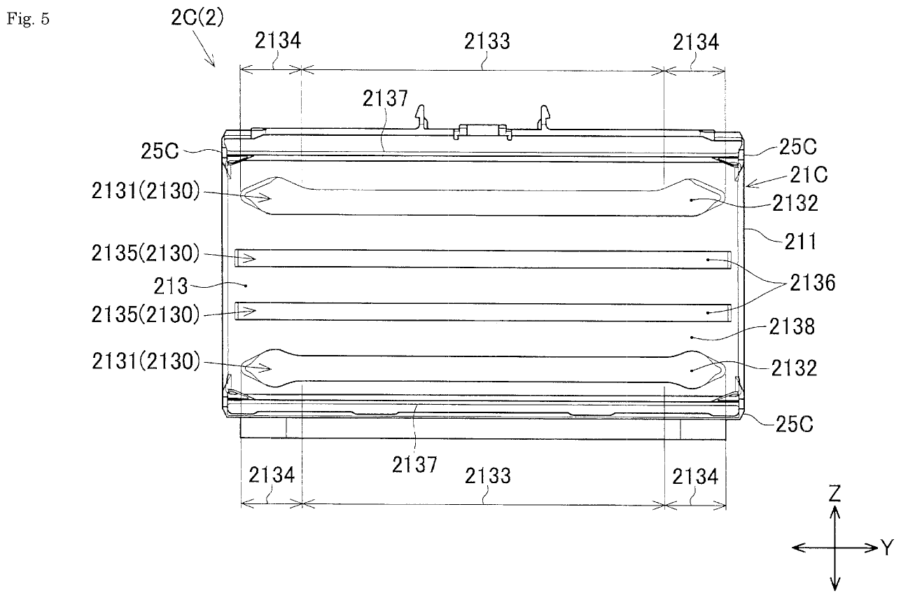

As also shown in FIGS. 5 to 8, each of the two third adjacent members 2C includes: a third body part 21C which expands in a direction orthogonal to the X-axis direction between the energy storage device 10 disposed adjacently in the X-axis direction and a part (in the example of the present embodiment, the terminal member 31) of the holding member 3; and at least one third restricting part 25C which restricts the movement of the energy storage device 10 disposed adjacently to the third body part 21C with respect to the third body part 21C. Each of the two third adjacent members 2C forms at least one flow path R through which the fluid for regulating the temperature can flow between the third adjacent member 2C and the adjacent energy storage device 10.

The third body part 21C includes a plate-shaped base portion 211 extending along a direction orthogonal to the X-axis direction, a peripheral wall 215 extending in the X-axis direction from a peripheral edge of the base portion 211, and a first wall 216 and a second wall 217 extending in the X-axis direction and extending in the Y-axis direction from the base portion 211.

The base portion 211 includes a first surface 212 which expands along a direction orthogonal to the X-axis direction and faces the member 31 forming the holding member 3, and a second surface 213 which expands along a direction orthogonal to the X-axis direction and faces the energy storage device 10. That is, the base portion 211 is a plate-like portion which expands along a direction orthogonal to the X-axis direction, and includes the first surface 212 which faces one side in the X-axis direction and the second surface 213 which is a back surface (a surface facing the other side in the X-axis direction) of the first surface 212 and faces the other side in the X-axis direction.

The first surface 212 of the base portion 211 includes a first recess 2121 recessed toward the second surface 213 at a position (opposite position, overlapping position as viewed in X-axis direction) corresponding to the first protruding part 331A extending from the terminal member 31, and the second surface 213 includes a first contact portion (contact portion) 2132 abutting on the energy storage device 10, and a space forming portion 2138 disposed at a position where a gap is formed with the energy storage device 10 in the X-axis direction. The details are as follows.

The second surface 213 of the base portion 211 has a plurality of projecting ridges 2130 which project toward the energy storage device 10 and extend in the Y-axis direction. The tip of at least one projecting ridge 2131 in the projecting direction out of the plurality of projecting ridges 2130 is configured of a first contact portion 2132. The second surface 213 includes a pair of seal portions 2137 extending in the Y-axis direction at both one end portion and the other end portion in the Z-axis direction.

The plurality of projecting ridges 2130 are disposed on the second surface 213 at intervals in the Z-axis direction, and the tips of the plurality of projecting ridges in the projecting direction are brought into contact with the energy storage devices 10. The plurality of projecting ridges 2130 include two types of projecting ridges (first projecting ridges 2131 and second projecting ridges 2135). The base portion 211 of the present embodiment includes two first projecting ridges 2131 and two second projecting ridges 2135. In the base portion 211 of the present embodiment, a region excluding the projecting ridges 2130 (first projecting ridges 2131, second projecting ridges 2135) and the seal portions 2137 at a portion of the second surface 213 facing the energy storage devices 10 forms the above-mentioned space forming portion 2138.

Each of the two first projecting ridges 2131 is disposed on the second surface 213 so as to be adjacent to the seal portion 2137 at a predetermined interval on the inner side of the seal portion 2137 in the Z-axis direction (the center side of the second surface 213 in the Z-axis direction). Each of the first projecting ridges 2131 includes the first contact portion 2132 which extends from one end portion of the second surface 213 in the Y-axis direction to the other end portion thereof, expands in a direction orthogonal to the X-axis direction at the tip thereof in the projecting direction, and is brought into contact with the energy storage device 10.

The first contact portion 2132 includes an extending portion (second portion) 2133 extending in the Y-axis direction and having the same dimension in the Z-axis direction at each position in the Y-axis direction, and an end portion (first portion) 2134 connected to an end portion of the extending portion 2133 in the Y-axis direction. In the first contact portion 2132 of the present embodiment, the end portion 2134 is connected to each end portion of the extending portion 2133 in the Y-axis direction. That is, the first contact portion 2132 includes two end portions 2134. The maximum dimension of each of the end portions 2134 in the Z-axis direction is larger than the dimension of the extending portion 2133 in the Z-axis direction.

The two second projecting ridges 2135 are disposed between the two first projecting ridges 2131 in the Z-axis direction. Each of the second projecting ridges 2135 includes the second contact portion 2136 which extends from one end portion of the second surface 213 in the Y-axis direction to the other end portion thereof, expands in a direction orthogonal to the X-axis direction at the tip thereof in the projecting direction, and is brought into contact with the energy storage device 10. The second contact portion 2136 has the same dimension in the Z-axis direction at each position in the Y-axis direction.

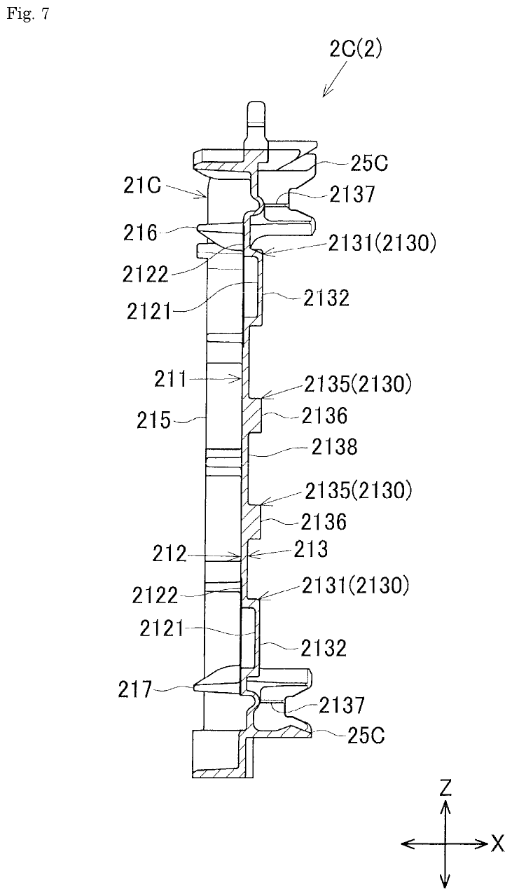

Each of the pair of seal portions 2137 protrudes in the X-axis direction and extends in the Y-axis direction, and a tip in the protruding direction is brought into contact with the energy storage device 10. The seal portion 2137 extends to the tip of the third restricting part 25C (see FIG. 7).

Between the second surface 213 configured as described above and the energy storage device 10 disposed adjacently to the second surface 213, the flow path R is formed between the projecting ridges 2130 disposed adjacently to each other in the Z-axis direction or between the projecting ridge 2130 and the seal portion 2137. Each of the flow paths R extends in the Y-axis direction along the corresponding projecting ridge 2130.

The first surface 212 of the base portion 211 has a rectangular shape corresponding to the energy storage device 10 as viewed in the X-axis direction, more specifically, a rectangular shape elongated in the Y-axis direction, and includes first recesses 2121 at four corners. That is, the first surface 212 includes four first recesses 2121. The first surface 212 includes second recesses 2122 shallower than the first recesses 2121 around the first recesses 2121, respectively. That is, the first surface 212 includes four second recesses 2122.

Each of the four first recesses 2121 includes: a first bottom surface 2121a which expands in a direction orthogonal to the X-axis direction; and a first inner peripheral surface 2121b which extends in a direction away from the energy storage device 10 in the X-axis direction from the peripheral edge of the first bottom surface 2121a. The first bottom surface 2121a of the present embodiment has a circular shape when viewed from the X-axis direction.

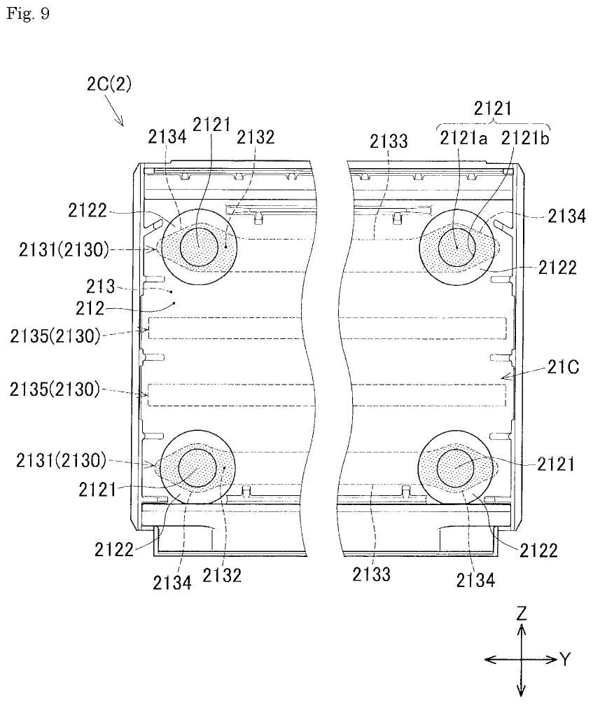

The first recess 2121 is disposed on the first surface 212 at a position corresponding to the first contact portion 2132 (specifically, the end portion 2134) of the second surface 213 (a position overlapping with the first contact portion 2132 as viewed in the X-axis direction) (see FIG. 9). In the first surface 212 of the present embodiment, two first recesses 2121 disposed at an interval in the Y-axis direction at one end portion of the first surface 212 in the Z-axis direction are disposed at positions corresponding to the first contact portions 2132 of the first projecting ridge 2131 extending in the Y-axis direction at one end portion of the second surface 213 in the Z-axis direction (positions overlapping the first contact portions 2132 as viewed in the X-axis direction). Two first recesses 2121 disposed at an interval in the Y-axis direction at the other end portion in the Z-axis direction are disposed at positions corresponding to the first contact portions 2132 of the first projecting ridge 2131 extending in the Y-axis direction at the other end portion of the second surface 213 in the Z-axis direction (positions overlapping the first contact portions 2132 as viewed in the X-axis direction).

More specifically, each of the first recesses 2121 is disposed on the first surface 212 at a position overlapping the end portion 2134 of the first contact portion 2132 as viewed in the X-axis direction (see FIG. 9). In other words, each of the first recesses 2121 is located inside a region (specifically, a region where the dimension in the Z-axis direction changes in the first projecting ridge 2131: a region to which smoke is applied in FIG. 9) corresponding to the end portion 2134 in the first projecting ridge 2131 on the first surface 212 as viewed in the X-axis direction.

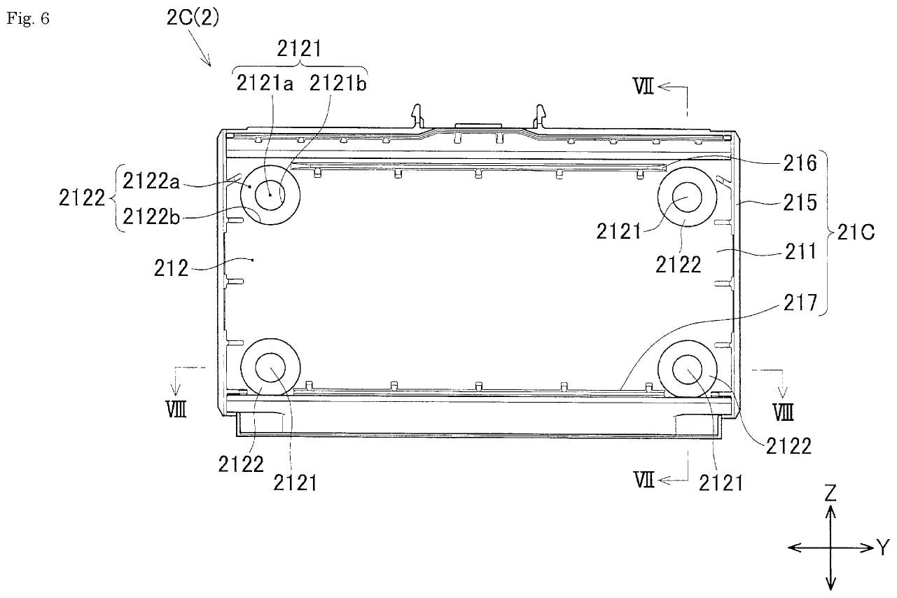

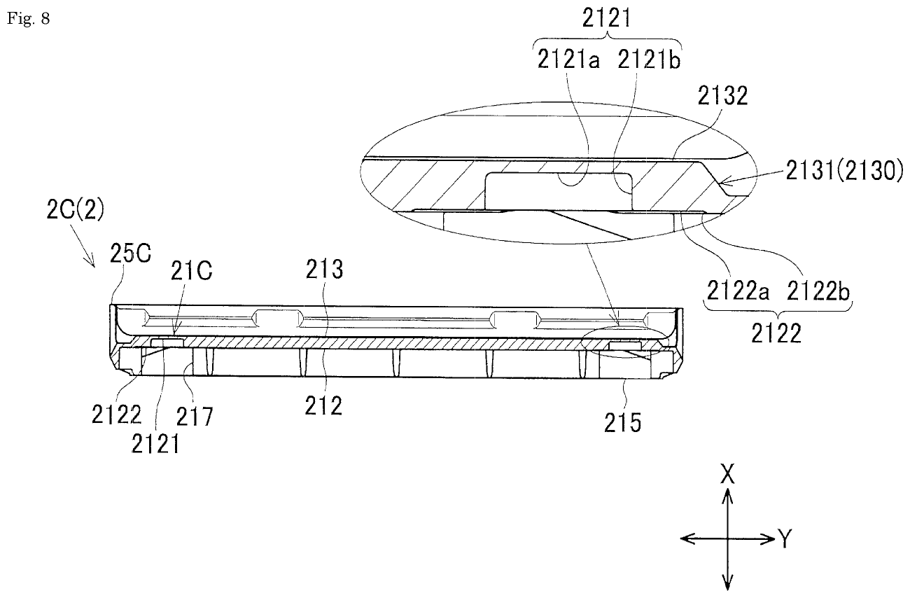

Each of the four second recesses 2122 includes: a second bottom surface 2122a which surrounds the first recess 2121 and expands in a direction orthogonal to the X-axis direction; and a second inner peripheral surface 2122b which extends in a direction away from the energy storage device 10 in the X-axis direction from the outer peripheral edge of the second bottom surface 2122a (see FIGS. 6 and 8). The outer peripheral edge and the inner peripheral edge of the second bottom surface 2122a of the present embodiment are concentric circular when viewed from the X-axis direction. In the present embodiment, the second inner peripheral surface 2122b has a tapered shape in which a diameter of the second inner peripheral surface increases in a direction away from the energy storage device 10 in the X-axis direction.

The peripheral wall 215 extends from the peripheral edge of the rectangular base portion 211 in a direction away from the energy storage device 10 in the X-axis direction.

The first wall 216 extends in the X-axis direction and in the Y-axis direction from the first surface 212. The first wall 216 is disposed at one end portion of the first surface 212 in the Z-axis direction, and a predetermined interval is formed between each end portion of the first wall 216 in the Y-axis direction and the peripheral wall 215.

The second wall 217 extends in the X-axis direction and in the Y-axis direction from the first surface 212. The second wall 217 is disposed at the other end portion of the first surface 212 in the Z-axis direction, and a predetermined interval is formed between each end portion of the second wall 217 in the Y-axis direction and the peripheral wall 215.

The third restricting parts 25C extend in the X-axis direction from at least corner portions of the rectangular third body part 21C or peripheral portions thereof, and are brought into contact with the energy storage device 10 (to be more specific, the case 11) disposed adjacently to the third body part 21C from the outside in the Y-Z plane direction thus restricting the relative movement of the energy storage device 10 in the Y-Z plane direction with respect to the third body part 21C. The third restricting part 25C of the present embodiment extends toward one side (the energy storage device 10 side) in the X-axis direction from the third body part 21C.

Returning to FIGS. 1 to 4, the holding member 3 collectively holds the plurality of energy storage devices 10 and the plurality of adjacent members 2 (that is, a layered product D) by surrounding the peripheries of the plurality of energy storage devices 10 and the plurality of adjacent members 2. The holding member 3 is made of a conductive member such as metal.

To be more specific, the holding member 3 includes: a pair of terminal members 31 which are disposed on both sides of the plurality of energy storage devices 10 (to be specific, the layered product D including the plurality of energy storage devices 10) in the X-axis direction; and connecting members 32 which extend along the X-axis direction at positions which are disposed adjacently to the plurality of energy storage devices 10 in the Y-axis direction and connect the pair of terminal members 31 to each other. The holding member 3 of the present embodiment includes a pair of connecting members 32 arrayed at an interval in the Y-axis direction, and each of the pair of connecting members 32 connects the end portions in the Y-axis direction of the pair of terminal members 31. The holding member 3 includes at least one fastening member 33 that fastens the terminal member 31 and the connecting member 32. The holding member 3 of the present embodiment includes a plurality of (eight in the example illustrated in FIG. 1) fastening members 33.

Each of the pair of terminal members 31 is disposed so as to interpose the third adjacent member 2C between the terminal member 31 and the energy storage device 10 disposed at an end (outermost side) in the X-axis direction. Each of the pair of terminal members 31 has a rectangular plate shape having a size corresponding to the size of the energy storage device 10 as viewed in the X-axis direction. Specifically, each terminal member 31 has a rectangular shape elongated in the Y-axis direction as viewed in the X-axis direction. Each of the terminal members 31 has two through holes 311 disposed at both ends in the Y-axis direction with a gap therebetween in the Z-axis direction. That is, the rectangular terminal member 31 includes the through holes 311 at the four corners. The terminal member 31 of the present embodiment has the through holes 311 at positions corresponding to the first recesses 2121 of the third adjacent member 2C, specifically, at positions overlapping the first recesses 2121 as viewed in the X-axis direction.

Each of the pair of connecting members 32 includes: a connecting member body 320 which faces the short wall 124 of each energy storage device 10; a first piece part 321 which extends in the Y-axis direction along the lid plate 13 of each energy storage device 10 from one end portion of the connecting member body 320 in the Z-axis direction and extends in the X-axis direction; a second piece part 322 which extends in the Y-axis direction along the closing part 121 of each energy storage device 10 from the other end portion of the connecting member body 320 in the Z-axis direction and extends in the X-axis direction; and a pair of third piece parts 323 which extends in the Y-axis direction along the terminal member 31 from each end portion of the connecting member body 320 in the X-axis direction and extends in the Z-axis direction.

The connecting member body 320 has a plate shape extending along the short wall 124 of each energy storage device 10, and has a plurality of through holes 3201 penetrating in the Y-axis direction so that the fluid for regulating the temperature can flow into or flow out of each flow path R.

The first piece part 321 has a band shape elongated in the X-axis direction, and has a constant dimension (width) in the Y-axis direction at each position excluding both end portions in the X-axis direction. The second piece part 322 has a band shape elongated in the X-axis direction, and has a constant dimension (width) in the Y-axis direction at each position excluding both end portions in the X-axis direction. The width of the second piece part 322 is larger than the width of the first piece part 321. Each of the pair of third piece parts 323 includes two through holes 3231 disposed at intervals in the Z-axis direction. Each through hole 3231 is disposed at a position corresponding to the through hole 311 of the terminal member 31, that is, at a position corresponding to the first recess 2121 of the third adjacent member 2C (a position overlapping the first recess 2121 as viewed in the X-axis direction).

Each of the plurality of fastening members 33 fastens the terminal member 31 and the connecting member 32 in a state of being inserted through the through hole 311 of the terminal member 31 and the through hole 3231 of the connecting member 32 (to be specific, the third piece part 323). Specifically, each fastening member 33 includes a bolt 331 and a nut 332.

The nut 332 is disposed at a position corresponding to the through hole 311 of the terminal member 31 between the terminal member 31 and the third adjacent member 2C (a position overlapping the through hole 311 as viewed in the X-axis direction), and the bolt 331 is screwed with the nut 332 in a state of being inserted through the through holes 3231, 311 in a direction from the third piece part 323 toward the terminal member 31. With such a configuration, the terminal member 31 and the third piece part 323 of the connecting member 32 are connected to each other. At this point, the tip of the bolt 331 protrudes from the nut 332 toward the third adjacent member 2C (see FIG. 4). The diameter of the shaft portion of the bolt 331 of the present embodiment is smaller than the diameter of the first recess 2121 of the third adjacent member 2C (the inner diameter of the first inner peripheral surface 2121b). The maximum outer diameter of the nut 332 is smaller than the diameter of the second recess 2122 (the inner diameter of the second inner peripheral surface 2122b).

In a state where the terminal member 31 and the connecting member 32 are connected to each other, the tip portion of the bolt 331 and the nut 332 protrude from the terminal member 31 toward the third adjacent member 2C. Specifically, the tip portion of the bolt 331 protrudes from the terminal member 31 toward the third adjacent member 2C, and the nut 332 protrudes from the terminal member 31 toward the third adjacent member 2C around the bolt 331. At this point, the protrusion amount of the nut 332 from the terminal member 31 is smaller than the protrusion amount of the bolt 331 from the terminal member 31. A portion of the bolt 331 protruding from the terminal member 31 forms the first protruding part 331A, and the nut 332 forms the second protruding part 332A (see FIG. 4). In the energy storage apparatus 1 of the present embodiment, the tip end (that is, the tip of the first protruding part 331A) of the bolt 331 slightly enters the first recess 2121 of the third adjacent member 2C in the X-axis direction.

The insulator 5 has an insulating property. The insulator 5 is disposed between the connecting member 32 and the plurality of energy storage devices 10. To be specific, the energy storage apparatus 1 includes a pair of insulators 5, and each insulator 5 covers at least a region of the connecting member 32 which faces the plurality of energy storage devices 10. With such a configuration, each insulator 5 provides insulation between the connecting member 32 and the plurality of energy storage devices 10. A through hole 51 having a size and a shape corresponding to those of each through hole 3201 of the connecting member body 320 is provided at each position (a position overlapping with the through hole 3201 as viewed in the Y-axis direction) corresponding to each through hole 3201 of the connecting member body 320 in each insulator 5.

Each of the plurality of bus bars 6 is a plate-like member having conductivity such as metal. Each of the bus bars 6 makes the external terminals 14 of the energy storage devices 10 conductive with each other. The plurality of bus bars 6 of the present embodiment connect (conduct) the plurality of energy storage devices 10 included in the energy storage apparatus 1 in series.

According to the energy storage apparatus 1 described above, contact between the first protruding part 331A and the third adjacent member 2C can be prevented by providing the first recess 2121 at a position corresponding to the first protruding part 331A (in the example of the present embodiment, a portion of the bolt 331 protruding from the terminal member 31) on the first surface 212 of the third adjacent member 2C (the position overlapping the first protruding part 331A as viewed in the X-axis direction).

In addition, by disposing the first recess 2121 using a portion (a portion corresponding to the first contact portion 2132) of the adjacent member 2C which protrudes toward the energy storage device 10 in order to form a space (gap) which can be used for heat insulation, cooling, and the like of the energy storage device 10, it is also possible to prevent an increase in size (thickness increase) of the third adjacent member 2C in the X-axis direction. That is, when the first recess 2121 is provided in a portion of the third adjacent member 2C corresponding to the space forming portion 2138 (in other words, a portion having a smaller dimension in the X-axis direction than a portion corresponding to the first contact portion 2132), the dimension of the third adjacent member 2C in the X-axis direction increases if the dimension of the third adjacent member 2C in the X-axis direction is secured to secure the strength and the like of the portion corresponding to the first recess 2121. However, by providing the first recess 2121 in a portion of the third adjacent member 2C corresponding to the first contact portion 2132 (in other words, a portion having a larger dimension in the X-axis direction than a portion corresponding to the space forming portion 2138), the strength of the portion corresponding to the first recess 2121 can be secured without increasing the dimension of the third adjacent member 2C in the X-axis direction.

In the energy storage apparatus 1 of the present embodiment, the tip of the first protruding part 331A (the bolt 331) slightly enters the first recess 2121 in the X-axis direction. However, the present invention is not limited to this configuration, and the tip may not enter the first recess 2121. Even in this case, when the third adjacent member 2C is pushed outward in the X-axis direction due to expansion of the respective energy storage devices 10 caused by aged deterioration or the like, contact between the third adjacent member 2C and the first protruding part 331A can be prevented by providing the first recess 2121 in the third adjacent member 2C.

In the energy storage apparatus 1 of the present embodiment, the first recess 2121 for preventing interference with the first protruding part 331A of the terminal member 31 is disposed inside the range where the first contact portion 2132 which maintains the position of the space forming portion 2138 with respect to the energy storage device 10 by abutting on the energy storage device 10 is formed, that is, a region of the second surface 213 corresponding to the first recess 2121 of the first surface 212 as viewed in the X-axis direction is brought into contact with the energy storage device 10 as a contact surface (first contact portion 2132) at a position where the region protrudes from the space forming portion 2138 toward the energy storage device 10. With such a configuration, it is possible to suppress crushing of a space which is formed between the space forming portion 2138 and the energy storage device 10 and can be used as a heat insulation space or a flow path space for the fluid for regulating the temperature (in the example of the present embodiment, the flow path R) in the X-axis direction, and to miniaturize the third adjacent member 2C in the X-axis direction.

In the energy storage apparatus 1 of the present embodiment, the second surface 213 includes the plurality of projecting ridges 2130 which project toward the energy storage device 10 and extend in the Y-axis direction. The plurality of projecting ridges 2130 are disposed on the second surface 213 at intervals in the Z-axis direction, and at least one tip of the plurality of projecting ridges in a projecting direction is brought into contact with the energy storage device 10. The tip of at least one projecting ridge (first projecting ridge) 2130 out of the plurality of projecting ridges 2131 is configured of the first contact portion 2132, and the first recess 2121 is disposed at a position corresponding to the at least one projecting ridge 2131 on the first surface 212 (a position overlapping the projecting ridge 2131 as viewed in the X-axis direction) (see FIG. 9).

With such a configuration, the plurality of flow paths (flow path spaces) R which extend in the Y-axis direction along the projecting ridge 2130 and through which the fluid for regulating the temperature of the energy storage device 10 can flow are formed between the energy storage device 10 and the third adjacent member 2C, and the first recess 2121 is formed in the portion where the projecting ridge (specifically, the first projecting ridge including the first contact portion 2132) 2131 is formed in the third adjacent member 2C, whereby the dimension of the third adjacent member 2C in the X-axis direction can be suppressed.

In the energy storage apparatus 1 of the present embodiment, in the at least one projecting ridge 2131, a dimension (maximum dimension) of an end portion (first portion) 2134 in the Z-axis direction which corresponds to the first recess 2121 in the Y-axis direction is larger than a dimension (maximum dimension) of an extending portion (second portion) 2133 in the Z-axis direction which is a portion other than the end portion 2134. According to such a configuration, in the flow path (flow path space) R formed by the first projecting ridge 2131 including the end portion 2134, the width (dimension in the Z-axis direction) of the portion corresponding to the end portion 2134 in the Y-axis direction is smaller than the width of the other portion (portion corresponding to the extending portion 2133). For this reason, the width of the flow path R is locally narrowed in the Y-axis direction, whereby a turbulent flow is generated in the flow of the fluid for regulating the temperature when the fluid for regulating the temperature flows in the flow path R, and as a result, the heat exchange efficiency between the energy storage device 10 and the fluid for regulating the temperature is improved.

The energy storage apparatus 1 of the present embodiment further includes the second protruding part 332A which protrudes toward the third adjacent member 2C from the terminal member 31 around the first protruding part 331A, the protruding amount of the second protruding part 332A is smaller than the protruding amount of the first protruding part 331A, the first surface 212 includes the second recess 2122 disposed at a position corresponding to the second protruding part 332A around the first recess 2121 (a position overlapping with the second protruding part 332A as viewed in the X-axis direction), and the depth of the second recess 2122 in the first direction is shallower than the depth of the first recess 2121 in the first direction. As described above, by providing the recesses (the first recess 2121 and the second recess 2122) in a range and a depth corresponding to the protruding parts 33A (the first protruding part 331A and the second protruding part 332A) protruding from the terminal member 31 on the first surface 212 of the third adjacent member 2C, interference with the protruding parts 33A of the third adjacent member 2C can be suppressed more reliably.

It is needless to say that the energy storage apparatus of the present invention is not limited to the above-mentioned embodiment, and various modifications can be made within the scope not departing from the gist of the present invention. The configuration of another embodiment can be added to the configuration of one embodiment, and a part of the configuration of one embodiment can be replaced with the configuration of another embodiment. A part of the configuration of an embodiment can be deleted.

In the energy storage apparatus 1 of the above-mentioned embodiment, the protruding part 33A which protrudes from the terminal member 31 toward the third adjacent member 2C is formed of the bolt 331 and the nut 332. However, the configuration of the protruding part 33A is not limited thereto. The protruding part 33A may be a head portion (a portion having a diameter larger than that of the shaft portion at an end of the shaft portion) of the bolt 331. In this case, the shaft portion of the bolt 331 may protrude from the terminal member 31 to the outside in the X-axis direction (the side opposite to the third adjacent member 2C), and the head portion of the bolt 331 may be located inside the terminal member 31 in the X-axis direction (the third adjacent member 2C side). In this case, the nut 332 may be screwed (engaged) with the shaft portion of the bolt 331 on the outer side of the terminal member 31 in the X-axis direction to be exposed to the outside. The protruding part 33A may be formed of another fastening member (for example, rivets and the like) which fastens the terminal member 31 and the connecting member 32 to each other. The protruding part 33A may be formed of a member or a portion other than the fastening member 33 which fastens the terminal member 31 and the connecting member 32 to each other.

In the energy storage apparatus 1 of the above-mentioned embodiment, the protruding part 33A is formed of a member different from the terminal member 31, but the present invention is not limited to such a configuration. The protruding part 33A may be formed integrally with the terminal member 31 by a part of the terminal member 31. That is, the terminal member may have a terminal member body (a portion corresponding to the terminal member 31 of the above embodiment) expanding along the direction orthogonal to the X-axis direction, and a protruding part (a portion corresponding to the bolt 331 and the nut 332 of the above embodiment) protruding from the terminal member body toward the third adjacent member 2C, and the terminal member body and the protruding part may be integrated.

The protruding part 33A of the above embodiment includes the first protruding part 331A and the second protruding part 332A, but is not limited to this configuration. The protruding part 33A may be formed only of the first protruding part 331A.

On the second surface 213 of the third adjacent member 2C in the above embodiment, the first projecting ridge 2131 extending in the Y-axis direction includes the first contact portion 2132, but the present invention is not limited to this configuration. The portion (region) having the first contact portion 2132 may have a columnar shape or the like extending in the X-axis direction.

In the energy storage apparatus 1 of the above-mentioned embodiment, the first contact portion 2132 and the second contact portion 2136 are brought into contact with the energy storage device 10 respectively. However, the first contact portion 2132 and the second contact portion 2136 may be brought into contact not only directly but also indirectly with the energy storage device 10 respectively. The first contact portion 2132 and the second contact portion 2136 can be brought into contact with the energy storage device 10 via any member interposed therebetween.

In the above embodiment, the case where the energy storage device is used as a chargeable/dischargeable nonaqueous electrolyte secondary battery (for example, a lithium ion secondary battery) has been described, but the type and size (capacity) of the energy storage device are arbitrary. In the above embodiment, the lithium ion secondary battery has been described as an example of the energy storage device, but the present invention is not limited thereto. The present invention is also applicable to various secondary batteries, primary batteries, and energy storage devices of capacitors such as electric double layer capacitors.

### DESCRIPTION OF REFERENCE SIGNS

1: energy storage apparatus
2: adjacent member
2A: first adjacent member
21A: first body part
25A: first restricting part
2B: second adjacent member
21B: second body part
211B: projecting ridge
212B: opposing surface
22B: second fastening member
25B: second restricting part
2C: third adjacent member
21C: third body part
211: base portion
212: first surface
2121: first recess
2121a: first bottom surface
2121b: first inner peripheral surface
2122: second recess
2122a: second bottom surface
2122b: second inner peripheral surface
213: second surface
2130: projecting ridge
2131: first projecting ridge
2132: first contact portion (contact portion)
2133: extending portion (second portion)
2134: end portion (first portion)
2135: second projecting ridge
2136: second contact portion
2137: seal portion
2138: space forming portion
215: peripheral wall
216: first wall
217: second wall
25C: third restricting part
3: holding member
31: terminal member
311: through hole
32: connecting member
320: connecting member body
3201: through hole
321: first piece part
322: second piece part
323: third piece part
3231: through hole
33: fastening member
33A: protruding part
331: bolt
331A: first protruding part
332: nut
332A: second protruding part
4: first fastening member
5: insulator
51: through hole
6: bus bar
10: energy storage device
11: case
12: case body
121: closing part
122: body part
123: long wall
124: short wall
13: lid plate
14: external terminal
500: assembled battery
501: battery cell
502: case
503: cooling plate
504: end plate
506: restraint band
507: restrained body
508: screw
D: layered product
R: flow path

1. An energy storage apparatus comprising:
an energy storage device, an adjacent member, and a terminal member arrayed sequentially in a first direction; and
a first protruding part protruding from the terminal member toward the adjacent member, wherein
the adjacent member includes a first surface expanding in a direction orthogonal to the first direction and facing the terminal member, and a second surface expanding in a direction orthogonal to the first direction and faces the energy storage device, and
the first surface includes a first recess recessed toward the second surface at a position corresponding to the first protruding part.

2. The energy storage apparatus according to claim 1, wherein
the second surface includes a contact portion being brought into contact with the energy storage device, and a space forming portion provided at a position where a gap is formed between the space forming portion and the energy storage device in the first direction, and
the first recess is provided at a position corresponding to the contact portion on the first surface.

3. The energy storage apparatus according to claim 2, wherein
the second surface includes a plurality of projecting ridges projecting toward the energy storage device and extending in a second direction orthogonal to the first direction,
the plurality of projecting ridges are disposed on the second surface at intervals in a third direction orthogonal to each of the first direction and the second direction, and at least one tip of the plurality of projecting ridges in a projecting direction is brought into contact with the energy storage device,
a tip of at least one of the plurality of projecting ridges is configured of the contact portion, and
the first recess is provided at a position corresponding to the at least one projecting ridge on the first surface.

4. The energy storage apparatus according to claim 3, wherein in the at least one projecting ridge, a dimension of a first portion in the third direction corresponding to the first recess in the second direction is larger than a dimension of a second portion in the third direction being a portion other than the first portion.

5. The energy storage apparatus according to any one of claims 1 to 4, further comprising a second protruding part protruding from the terminal member toward the adjacent member around the first protruding part, wherein
a protruding amount of the second protruding part is smaller than a protruding amount of the first protruding part, and
the first surface includes a second recess provided at a position corresponding to the second protruding part around the first recess, and a depth of the second recess in the first direction is shallower than a depth of the first recess in the first direction.
